(19) United States
(12) Patent Application Publication
(10) Pub. No.: US 2007/0049241 A1
(43) Pub. Date: Mar. 1, 2007

(54) Remote controller device having a multi-function module that facilitates location of a wireless user-operated module

(75) Inventors: Joe Shih, Nan-Tou Hsien (TW); Han Chieh Lee, San Jose, CA (US); Jereny Lai, Taipei City (TW); Joseph Chen, Ta-Li City (TW)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Universal Scientific Industrial Co., Ltd.

(21) Appl. No.: 11/214,268

(22) Filed: Aug. 29, 2005

(51) Int. Cl. H04B 1/06; H04M 3/00

(52) U.S. Cl. 455/352; 455/419

(57) ABSTRACT

A remote controller device includes a wireless user-operated module and a multi-function module. The wireless user-operated module is operable so as to generate control signals for controlling operation of an electrical appliance, and includes a signal receiver, a sound generator, and a signal processor coupled to the signal receiver and the sound generator. The multi-function module is operable so as to transmit a paging signal for wireless reception by the signal receiver of the user-operated module. The signal processor responds to the paging signal received by the signal receiver of the user-operated module by activating the sound generator to generate an audible sound output.

### BACKGROUND OF THE INVENTION

1. Field of the Invention

The invention relates to a remote controller device, more particularly to a remote controller device that has a multi-function module, which facilitates location of a wireless user-operated module of the remote controller device.

2. Description of the Related Art

A conventional remote controller is operable so as to generate control signals for controlling operation of an electrical appliance.

The conventional remote controller is disadvantageous in that it cannot be easily located when misplaced. Furthermore, the conventional remote controller uses a non-rechargeable battery set that needs to be replaced once consumed. This causes inconvenience on the part of the user when a replacement battery set is not readily available.

### SUMMARY OF THE INVENTION

Therefore, the object of the present invention is to provide a remote controller device that is capable of overcoming the aforementioned drawbacks of the prior art.

According to the present invention, a remote controller device comprises a wireless user-operated module and a multi-function module. The wireless user-operated module is operable so as to generate control signals for controlling operation of an electrical appliance, and includes a signal receiver, a sound generator, and a signal processor that is coupled to the signal receiver and the sound generator. The multi-function module is operable so as to transmit a paging signal for wireless reception by the signal receiver of the user-operated module. The signal processor responds to the paging signal received by the signal receiver of the user-operable module by activating the sound generator to generate an audible sound output.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of the first preferred embodiment of a remote controller device according to the present invention;

FIG. 2 is a perspective view of the first preferred embodiment;

FIG. 3 is a schematic view of the first preferred embodiment to illustrate a user-operated module being charged by a multi-function module;

FIG. 4 is a schematic block diagram of the second preferred embodiment of a remote controller device according to the present invention;

FIG. 5 is a schematic block diagram of the third preferred embodiment of a remote controller device according to the present invention;

FIG. 6 is a perspective view of the fourth preferred embodiment of a remote controller device according to the present invention; and

FIG. 7 is a schematic view of the fifth preferred embodiment of a remote controller device according to the present invention.

### DETAILED DESCRIPTION OF THE PREFERRED EMBODIMENTS

Before the present invention is described in greater detail, it should be noted that like elements are denoted by the same reference numerals throughout the disclosure.

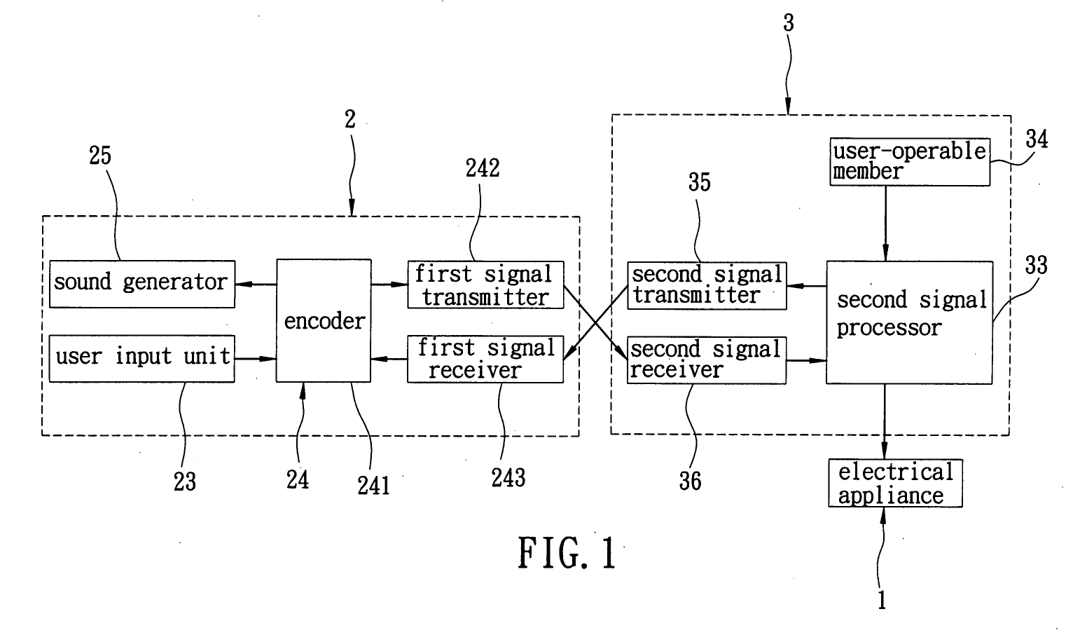

Referring to FIGS. 1 to 3, the first preferred embodiment of a remote controller device according to this invention is shown to include a wireless user-operated module 2 and a multi-function module 3.

In this embodiment, the wireless user-operated module 2 includes a first signal receiver 243, a sound generator 25, and a first signal processor 24.

The first signal processor 24 includes an encoder 241 that is coupled to the first signal receiver 243 and the sound generator 25. In this embodiment, the encoder 241 of the first signal processor 24 of the wireless user-operated module 2 is operable so as to generate control signals for controlling operation of an electrical appliance 1, such a television set, in a manner well known in the art.

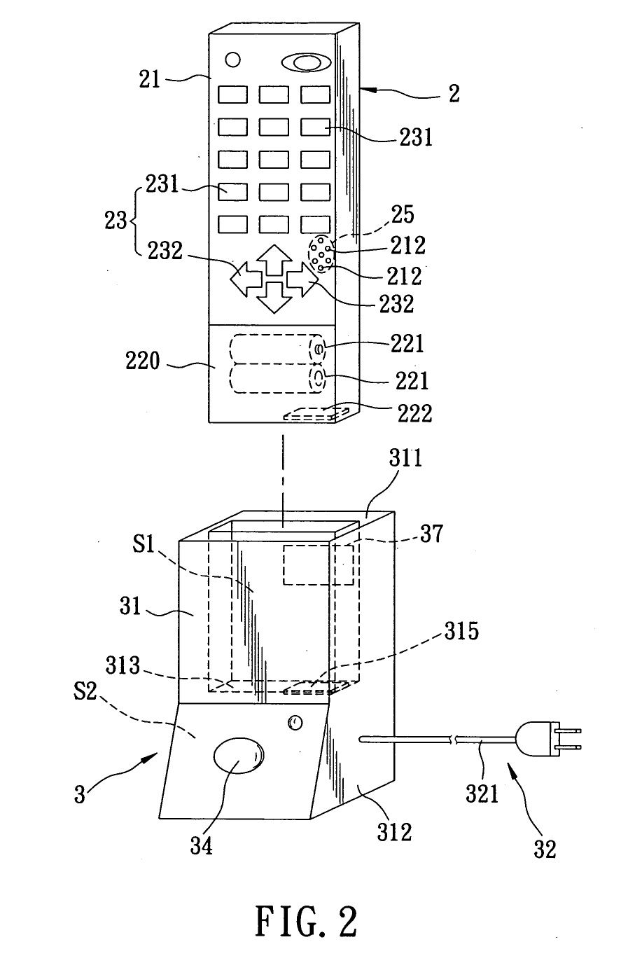

The wireless user-operated module 2 further includes a user input unit 23 and a first signal transmitter 242 that are coupled to the encoder 241 of the first signal processor 24. As best shown in FIG. 2, the user input unit 23 includes a plurality of numeric keys 231 and a plurality of function keys 232.

The encoder 241 of the first signal processor 24 is responsive to user manipulation of the numeric and function keys 231, 232 of the user input unit 23 to cause the first signal transmitter 242 to transmit the control signals corresponding to the user manipulation of the user input unit 23 for controlling operation of the electrical appliance 1.

The wireless user-operated module 2 further includes a first casing 21 that has the encoder 241 of the first signal processor 24, the first signal receiver 243, the first signal transmitter 242, and the sound generator 25 disposed therein, and the numeric and function keys 231, 232 of the user input unit 23 mounted thereon.

The first casing 21 of the wireless user-operated module 2 defines a battery compartment 220 adapted to receive a rechargeable battery set 221 therein. The encoder 241 of the first signal processor 24, the first signal receiver 243, the first signal transmitter 242, and the sound generator 25 are able to draw electric power from the battery set 221 in the battery compartment 220 in a manner well known in the art.

The wireless user-operated module 2 further includes a set of first charging contacts 222 mounted on the first casing 21, accessible externally of the battery compartment 220, and adapted to serve as external contacts for the battery set 221 in the battery compartment 220.

The first casing 21 of the wireless user-operated device 2 is formed with a plurality of sound holes 212. In this embodiment, the sound generator 25 is a beeper that is disposed adjacent to the sound holes 212.

The multi-function module 3 is operable so as to transmit a paging signal for wireless reception by the first signal receiver 243. In this embodiment, the multi-function module 3 includes a user-operable member 34, a second signal transmitter 35, and a second signal processor 33, such as a digital signal processor, that is coupled to the user-operable member 34 and the second signal transmitter 35.

The second signal processor 33 is responsive to user operation of the user-operable member 34 to cause the second signal transmitter 35 to transmit the paging signal for subsequent receipt by the encoder 241 through the first signal receiver 243. As best shown in FIG. 2, the user-operable member 34 is a push-button switch.

The encoder 241 of the first signal processor 24 responds to the paging signal received by the first signal receiver 243 by activating the sound generator 25 to generate an audible sound output.

It is noted that the multi-function module 3 is adapted to be connected electrically to the electrical appliance 1. In this embodiment, the multi-function module 3 further includes a second signal receiver 36 that is coupled to the second signal processor 33 and that provides the control signals transmitted by the first signal transmitter 242 and received thereby to the second signal processor 33. The second signal processor 38 responds by controlling the operation of the electrical appliance 1 accordingly.

In this embodiment, the multi-function module 3 further includes a second casing 31 that includes a base wall 311, a surrounding wall 312, and a dividing wall 313. The surrounding wall 312 extends from a periphery of the base wall 311 and cooperates with the base wall 311 to define an accommodating space. The dividing wall 313 divides the accommodating space into first and second portions (S1, S2). The second portion (S2) of the accommodating space of the second casing 31 has the second signal processor 33, the second signal receiver 36 and the second signal transmitter 35 disposed therein. The first portion (S1) of the accommodating space of the second casing 31 accommodates removably a part of the first casing 21 of the wireless user-operated module 2.

The multi-function module 3 further includes a set of second charging contacts 315 and a power supplying circuit 32. The second charging contacts 315 are mounted in the first portion (S1) of the accommodating space of the second casing 31 and are coupled to the first charging contacts 222 of the wireless user-operated module 2 when the first casing 21 of the wireless user-operated module 2 is accommodated in the first portion (S1) of the accommodating space of the second casing 31 of the multi-function module 3. The power supplying circuit 32 includes a power cord 321 that extends into the second portion (S2) of the accommodating space of the second casing 31, and that is adapted to be coupled to an external power source (not shown). The power supply circuit 32 is coupled to the second charging contacts 315, the second signal transmitter 35, the second signal receiver 36 and the second signal processor 33 so as to supply electric power thereto, and is operable so as to charge the battery set 221 in the first casing 21 when the first casing 21 of the wireless user-operated module 2 is accommodated in the first portion (S1) of the accommodating space of the second casing 31.

The multi-function module 3 further includes an adhesive strip 37 that is provided on the base wall 311 of the second casing 31 and that permits the multi-function module 3 to be attached to the electrical appliance 1 or to a wall (not shown).

It is noted that each of the first and second signal transmitters 242 and 35, and the first and second signal receivers 243, 36 operates at a carrier frequency of 2.4 GHz.

It is also noted that although the electrical appliance 1 in this embodiment is exemplified to be a television set, the electrical appliance 1 may be one of a VCD player, a DVD player, an air conditioner, heater, a mobile phone, etc.

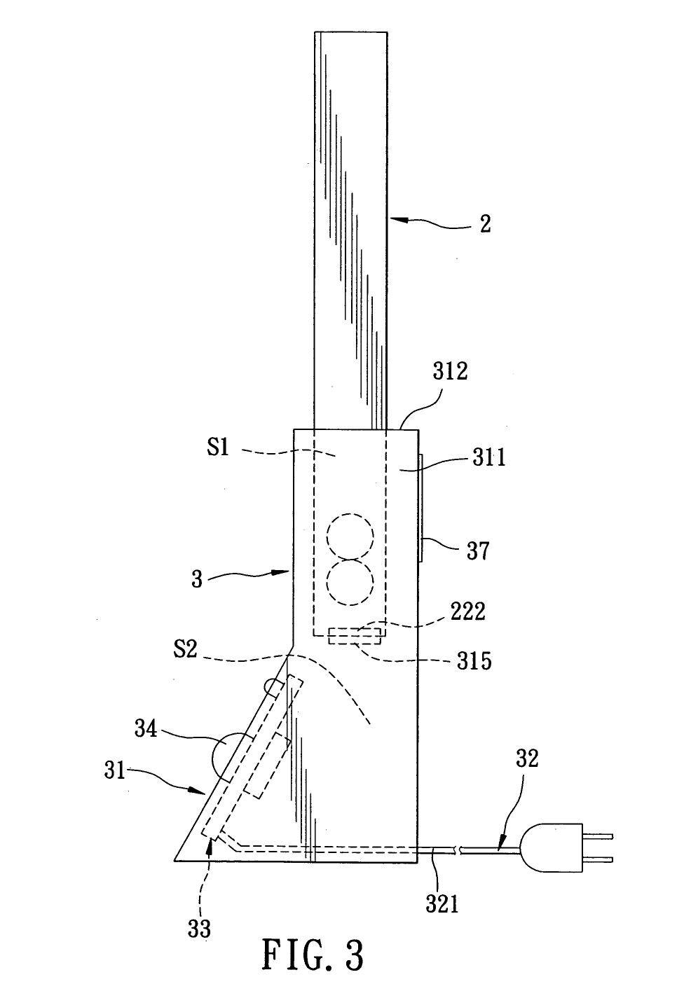

In use, when it is desired to recharge the battery set 221 in the battery compartment 220 of the first casing 21 of the wireless user-operated module 2, the first casing 21 of the wireless user-operated module 2 may be simply accommodated in the fist portion (S1) of the accommodating space of the second casing 31, as illustrated in FIG. 3, to thereby permit charging of the battery set 221 in the battery compartment 220 of the first casing 21. Moreover, when the wireless user-operated module 2 is misplaced, and when it is desired to locate the misplaced wireless user-operated module 2, the user-operable member 34 of the multi-function module 3 may be simply operated, to thereby enable transmission of the paging signal. Accordingly, upon receipt of the paging signal by the encoder 241 of the first signal processor 24 through the first signal receiver 243, the encoder 241 of the second signal processor 24 converts the paging signal into an actuating signal that activates the sound generator 25 to generate the audible sound output.

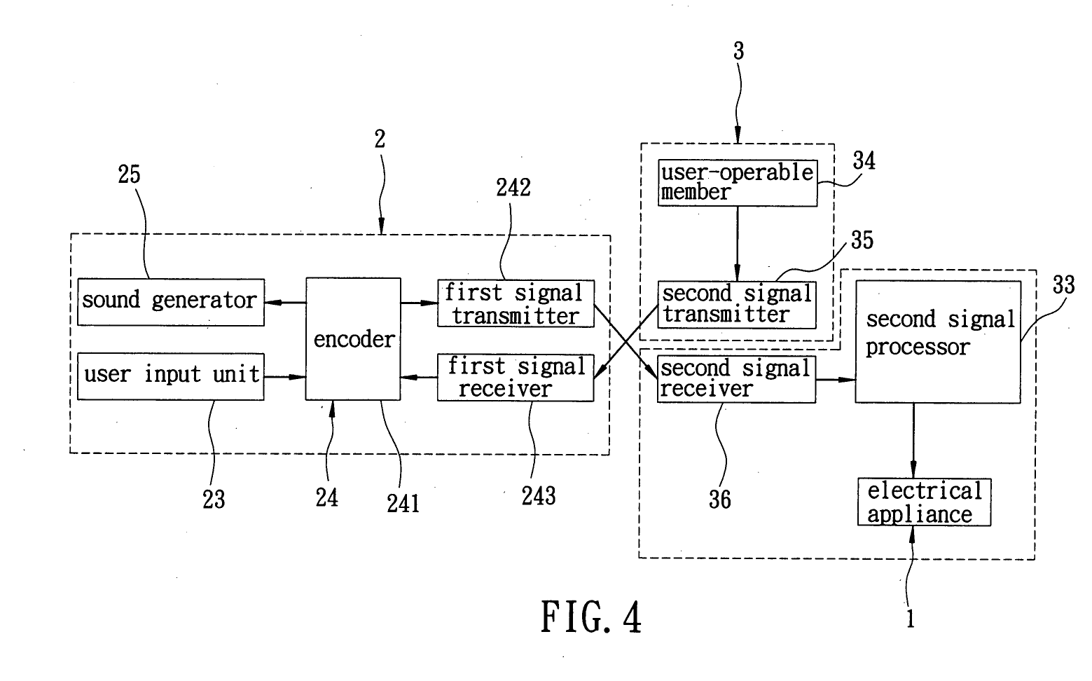

FIG. 4 illustrates the second preferred embodiment of a remote controller device according to the present invention. When compared with the previous embodiment, the second signal receiver 36 and the second signal processor 33 of the multi-function module 3 are configured for integration with the electrical appliance 1. Therefore, when the user-operable member 34 is operated, the second signal transmitter 35 is activated directly thereby for transmitting the paging signal.

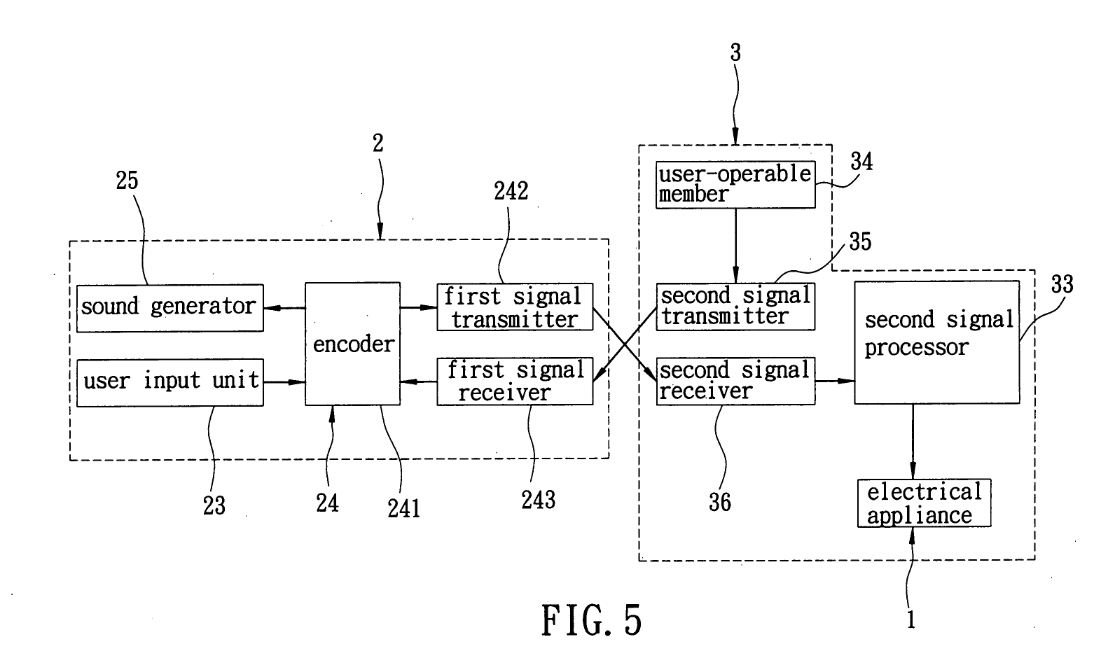

FIG. 5 illustrates the third preferred embodiment of a remote controller device according to the present invention. When compared with the first embodiment, the user-operable member 34, the second signal receiver 36, the second signal transmitter 35 and the second signal processor 33 of the multi-function module 3 are configured for integration with the electrical appliance 1.

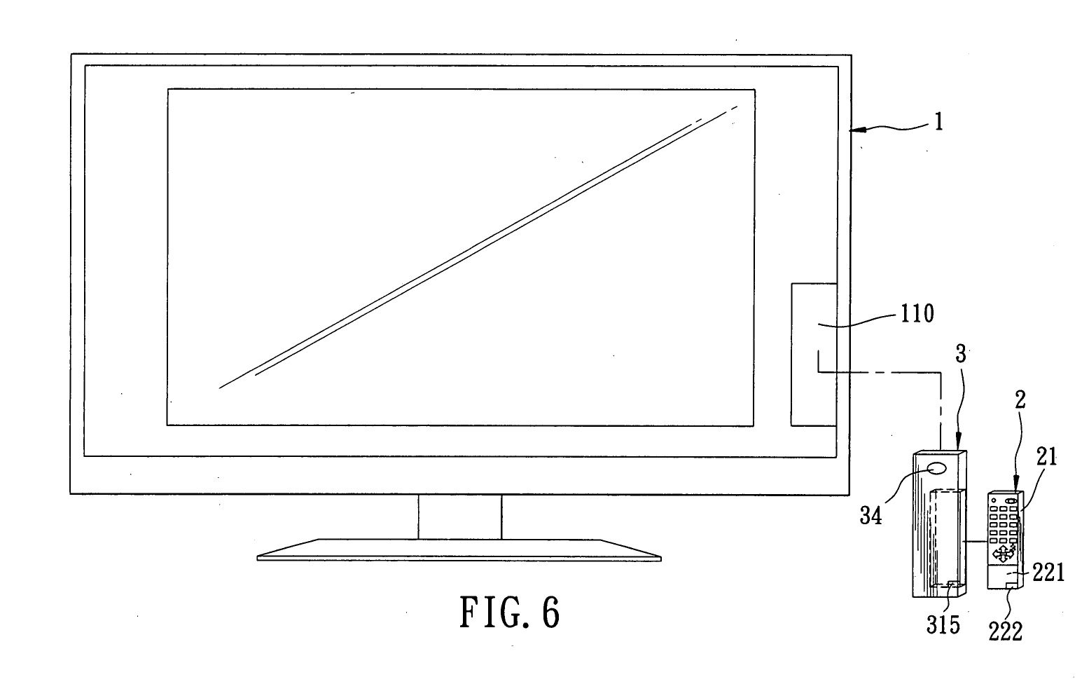

FIG. 6 illustrates the fourth preferred embodiment of a remote controller device according to the present invention. When compared with the first embodiment, the electrical appliance 1 defines an accommodating space 110. The second charging contacts 315 of the multi-function module 3 are adapted to be coupled to the electrical appliance 1 when the multi-function module 3 is disposed in the accommodating space 110, and are coupled to the first charging contacts 222 of the wireless user-operated module 2 when the first casing 21 of the wireless user-operated module 2 is accommodated in the accommodating space of the multi-function module 3 so as to permit charging of the battery set 221 in the first casing 21 of the wireless user-operated module 2 by the electrical appliance 1.

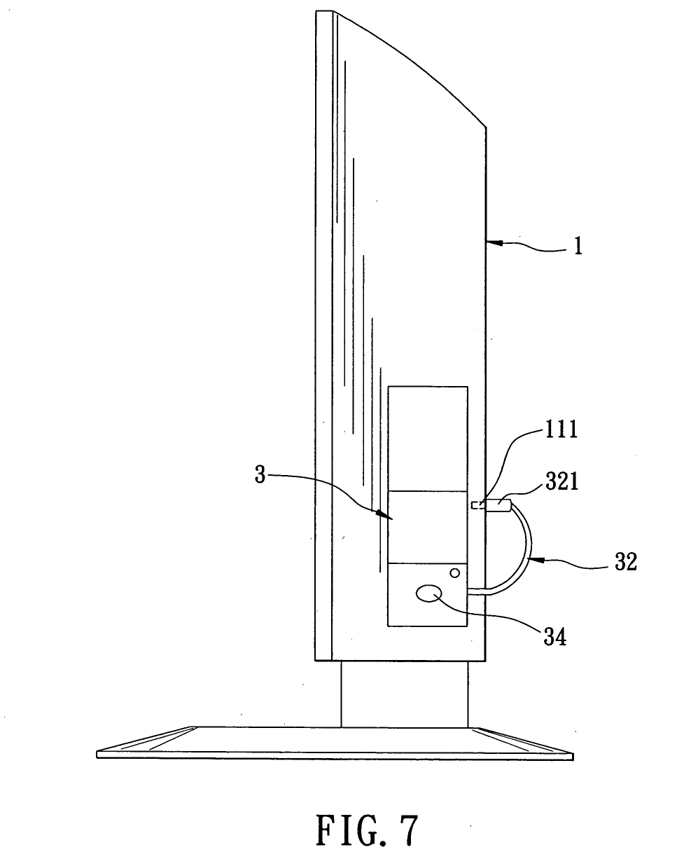

FIG. 7 illustrates the fifth preferred embodiment of a remote controller device according to the present invention. When compared with the first embodiment, the power cord 321 of the power supplying circuit 32 of the multi-function module 3 is adapted to be coupled to the external power source (not shown) through a power supplying circuit 111 of the electrical appliance 1.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A remote controller device, comprising:
a wireless user-operated module operable so as to generate control signals for controlling operation of an electrical appliance, said wireless user-operated module including a first signal receiver, a sound generator, and a first signal processor coupled to said first signal receiver and said sound generator; and
a multi-function module operable so as to transmit a paging signal for wireless reception by said first signal receiver;
wherein said first signal processor responds to the paging signal received by said first signal receiver by activating said sound generator to generate an audible sound output.

2. The remote controller device as claimed in claim 1, wherein said wireless user-operated module further includes a user input unit and a first signal transmitter coupled to said first signal processor, said first signal processor being responsive to user manipulation of said user input unit to cause said first signal transmitter to transmit the control signals corresponding to the user manipulation of said user input unit for controlling operation of the electrical appliance.

3. The remote controller device as claimed in claim 1, wherein said multi-function module includes a user-operable member, and a second signal transmitter responsive to operation of said user-operable member so as to transmit the paging signal for subsequent receipt by said first signal receiver of said wireless user-operated module.

4. The remote controller device as claimed in claim 3, wherein said multi-function module further includes a second signal processor coupled to said user-operable member and said second signal transmitter, said second signal processor being responsive to user operation of said user-operable member to cause said second signal transmitter to transmit the paging signal.

5. The remote controller device as claimed in claim 3, wherein said wireless user-operated module further includes a first casing having said first signal processor, said first signal receiver, and said sound generator disposed therein, and said multi-function module further includes a second casing having said second signal transmitter disposed therein and said user-operable member mounted thereon.

6. The remote controller device as claimed in claim 5, wherein said first casing of said wireless user-operated module defines a battery compartment adapted to receive a rechargeable battery set therein, at least one of said first signal processor, said first signal receiver and said sound generator being able to draw electric power from the battery set in said battery compartment.

7. The remote controller device as claimed in claim 6, wherein said wireless user-operated module further includes a set of first charging contacts mounted on said first casing, accessible externally of said battery compartment, and adapted to serve as external contacts for the battery set in said battery compartment.

8. The remote controller device as claimed in claim 5, wherein said second casing of said multi-function module defines an accommodating space for accommodating removably at least a part of said first casing of said wireless user-operated module.

9. The remote controller device as claimed in claim 7, wherein said multi-function module further includes a set of second charging contacts mounted in said second casing, and a power supplying circuit mounted in said second casing, adapted to be coupled to an external power source, coupled to said second charging contacts and at least one of said second signal transmitter and said second signal processor so as to supply electric power thereto, and operable so as to charge the battery set in said first casing when said second charging contacts are in electrical contacts with said first charging contacts of said wireless user-operated module.

10. The remote controller device as claimed in claim 5, wherein said first casing of said wireless user-operated device is formed with a plurality of sound holes, said sound generator being a beeper that is disposed adjacent to said sound holes.

11. The remote controller device as claimed in claim 2, wherein said multi-function module is adapted to be connected electrically to the electrical appliance, and includes a second signal receiver and a second signal processor coupled to said second signal receiver, said second signal processor being responsive to the control signals transmitted by said first signal transmitter and received through said second signal receiver so as to control the operation of the electrical appliance accordingly.

12. The remote controller device as claimed in claim 11, wherein said multi-function module further includes a user-operable member, and a second signal transmitter responsive to operation of said user-operable member so as to transmit the paging signal for subsequent receipt by said first signal receiver of said wireless user-operated module.

13. The remote controller device as claimed in claim 12, wherein said wireless user-operated module further includes a first casing having said first signal processor, said first signal receiver, said first signal transmitter, and said sound generator disposed therein, and said user input unit mounted thereon.

14. The remote controller device as claimed in claim 13, wherein said first casing of said wireless user-operated module defines a battery compartment adapted to receive a rechargeable battery set therein, at least one of said first signal processor, said first signal receiver, said first signal transmitter, and said sound generator being able to draw electric power from the battery set in said battery compartment.

15. The remote controller device as claimed in claim 14, wherein said wireless user-operated module further including a set of first charging contacts mounted on said first casing, accessible externally of said battery compartment, and adapted to serve as external contacts for the battery set in said battery compartment.

16. The remote controller device as claimed in claim 15, the electrical appliance defining an accommodating space for accommodating removably at least a part of said first casing of said wireless user-operated module, wherein said multi-function module further includes
a set of second charging contacts adapted to be disposed in the accommodating space, adapted to be coupled to the electrical appliance, and coupled to said first charging contacts of said wireless user-operated module when said first casing of said wireless user-operated module is accommodated in the accommodating space so as to permit charging of the battery set in said first casing of said wireless user-operated module by the electrical appliance.

17. The remote controller device as claimed in claim 11, wherein at least one of said user-operable member, said second signal receiver, said second signal transmitter and said second signal processor of said multi-function module is configured for integration with the electrical appliance.

18. The remote controller device as claimed in claim 17, wherein said second signal receiver and said second signal processor are configured for integration with the electrical appliance.
